(19) United States
(12) Patent Application Publication
(10) Pub. No.: US 2023/0359847 A1
(43) Pub. Date: Nov. 9, 2023

(54) CONTAINER INCLUDING RFID MODULE

(71) Applicant: Murata Manufacturing Co., Ltd., Nagaokakyo-shi (JP)

(72) Inventor: Noboru KATO, Nagaokakyo-shi (JP)

(21) Appl. No.: 18/355,868

(22) Filed: Jul. 20, 2023

Related U.S. Application Data
(63) Continuation of application No. PCT/JP22/02261, filed on Jan. 21, 2022.

(30) Foreign Application Priority Data
Jan. 22, 2021 (JP) 2021-008975

(51) Int. Cl. G06K 19/02; G06K 19/077; G06K 19/07; H01Q 1/22; H01Q 1/38

(52) U.S. Cl. CPC G06K 19/025; G06K 19/077; G06K 19/0723; H01Q 1/2208; H01Q 1/38

(57) ABSTRACT

A container is provided includes a base material having insulating properties that form an outer shape, a metal film on the base material, and a first slit in the metal film. The base material includes a first surface, a second surface, and a first flap continuous with the first surface. The first slit separates the metal film on the first flap into first and second metal regions. An RFID module includes an RFIC element, a filter circuit, and first and second electrodes connected to the filter circuit. The first electrode and the first metal region are electrically connected to each other. The second electrode and the second metal region are electrically connected to each other. The first metal region is continuous with the metal film on the first surface and the second metal region is capacitively coupled to the metal film on the second surface.

### CROSS REFERENCE TO RELATED APPLICATIONS

This application is a continuation of PCT/JP2022/002261, filed Jan. 21, 2022, which claims priority to Japanese Patent Application No. 2021-008975, filed on Jan. 22, 2021, the entire contents of each application of which are hereby incorporated by reference.

### TECHNICAL FIELD

The present invention relates to a container including an RFID module, and, in particular, to a container including an RFID module using a radio frequency identification (RFID) technology that performs data communication in a non-contact manner by an induction field or a radio wave.

### BACKGROUND

Conventionally, it has been considered to manage products in a container by attaching an RFID tag that is a wireless communication device to the container. In the RFID tag, a metal material, such as an antenna pattern, is formed on an insulating substrate such as a paper material or a resin material together with a radio-frequency integrated circuit (RFIC). However, when a metal film is formed on the outer surface of the container, the RFID tag is affected and communication cannot be performed.

In the RFID tagged container as described above, WO 2019/039484 (hereinafter “Patent Document 1”) proposes a configuration in which an RFID tag capable of corresponding to metal formed in a part of the container is provided so as not to impair designability.

In particular, the RFID tag disclosed in Patent Document 1 includes an RFIC chip and an antenna pattern, and a metal film cannot be formed on the container in these regions. Therefore, a container including an RFID module having an increased degree of freedom of designability is required.

### SUMMARY OF THE INVENTION

Accordingly, it is an object of the present invention to provide a container including an RFID module that improves designability in a container on which a metal film can be formed.

In an exemplary aspect, a container is provided that has an assembled-box shape and includes an RFID module. In this aspect, the container includes an RFID module having a base material with insulating properties configured to form an outer shape of the container; a metal film on the base material; and a first slit in the metal film. The base material includes a first surface and a second surface that serve as side surfaces, a top surface, and a bottom surface of the container, and a first flap continuous with the first surface. The first slit separates the metal film on the first flap into a first metal region and a second metal region. The RFID module includes an RFIC element, a filter circuit configured to transmit a current due to an electromagnetic wave at a natural resonance frequency being a communication frequency to the RFIC element, and first and second electrodes to be connected to the filter circuit. The first electrode of the RFID module and the first metal region of the metal film on the first flap are electrically connected to each other. The second electrode of the RFID module and the second metal region of the metal film on the first flap are electrically connected to each other. The first metal region of the metal film on the first flap is continuous with the metal film on the first surface. In an assembled state, the second metal region of the metal film on the first flap is capacitively coupled to the metal film on the second surface.

According to the exemplary aspects of the present invention, a container including an RFID module is provided with improved designability.

### BRIEF DESCRIPTION OF THE DRAWINGS

FIG. 1 is an overall perspective view of a container including an RFID module of a first exemplary embodiment.

FIG. 2 is a cross-sectional view taken along line indicated by arrows II in FIG. 1.

FIG. 3 is a developed view of the container in FIG. 1.

FIG. 4 is a perspective plan view of the RFID module.

FIG. 5 is a cross-sectional view taken along line indicated by arrows V in FIG. 4.

FIG. 6 is a plan view of a conductor pattern formed on a substrate of the RFID module.

FIG. 7 is a cross-sectional view taken along line indicated by arrows VII in FIG. 4.

FIG. 8 is a circuit diagram of the RFID module.

FIG. 9 is a graph showing communication characteristics of the RFID module.

FIG. 10 is a perspective view in which the containers of the first exemplary embodiment are arranged in a superposed manner.

FIG. 11 is a developed view of a container in a modification of the first exemplary embodiment.

FIG. 12 is a developed view of a container in a modification of the first exemplary embodiment.

FIG. 13 is a front view of a sixth surface of the assembled container 1 in a modification of the first exemplary embodiment.

FIG. 14 is a developed view of a container in a modification of the first exemplary embodiment.

FIG. 15 is a front view of a sixth surface of the assembled container 1 in a modification of the first exemplary embodiment.

FIG. 16 is a developed view of a container in a modification of the first exemplary embodiment.

### DETAILED DESCRIPTION

In an exemplary aspect of the present invention, a container is provided that has an assembled-box shape and includes an RFID module. In this aspect, the container includes an RFID module including a base material having insulating properties configured to form an outer shape of the container; a metal film on the base material; and a first slit in the metal film. The base material includes a first surface and a second surface that serve as any of a side surface, a top surface, and a bottom surface of the container, and a first flap continuous with the first surface. The first slit separates the metal film on the first flap into a first metal region and a second metal region. The RFID module includes an RFIC element, a filter circuit configured to transmit a current due to an electromagnetic wave at a natural resonance frequency being a communication frequency to the RFIC element, and first and second electrodes connected to the filter circuit. The first electrode of the RFID module is electrically connected to the first metal region of the metal film on the first flap. The second electrode of the RFID module electrically connected to the second metal region of the metal film on the first flap. The first metal region of the metal film on the first flap is continuous with the metal film on the first surface. In an assembled state of the container, the second metal region of the metal film on the first flap is electrically connected to the metal film on the second surface by capacitive coupling.

In another exemplary aspect, the first metal region and the second metal region of the metal film on the first flap of the container, and the metal film on the first surface continuous with the first metal region and the metal film on the second surface electrically connected to the second metal region are used as an antenna. Accordingly, in the container in which the metal film is formed, the RFID module can be attached to the container while improving the degree of freedom in designability.

In another exemplary, a second slit divides the metal film on the first surface and the metal film on the second surface.

In another exemplary, the base material may have a third surface continuous with each of the first surface and the second surface, and the second slit may be formed between the metal film on the second surface and the metal film on the third surface.

In another exemplary, the base material may include a first tuck flap continuous with the second surface on an opposite side from the third surface, and a third slit formed between the metal film on the second surface and the metal film on the first tuck flap may be provided.

In another exemplary, the metal film may be on an entire surface of the base material except for the first slit, the second slit, and the third slit. A design in which a metal film is formed on almost the entire surface of the first main surface of the container can also be achieved, and the degree of freedom in designability of the container can be improved.

In another exemplary, in an assembled state of the container, a metal film is not in the region of the second surface overlapping the first metal region of the metal film on the first flap.

In another exemplary, the base material may have a fourth surface continuous with the third surface on an opposite side from the second surface. The base material may include a second tuck flap continuous with the fourth surface on an opposite side from the third surface. A fourth slit formed between the metal film on the third surface and the metal film on the fourth surface may be provided. A fifth slit formed between the metal film on the fourth surface and the metal film on the second tuck flap may be provided.

In another exemplary, he base material includes: a third surface continuous with the first surface on an opposite side from the first flap, a fourth surface positioned between the second surface and the third surface, the fourth surface continuous with each of the second surface and the third surface, and a joining flap continuous with the second surface on an opposite side from the fourth surface. The second slit may be between the metal film on the second surface and the metal film on the fourth surface, and a third slit configured to separate the respective metal films may be formed between the metal film on the fourth surface and the metal film on the joining flap. In an assembled state, the second surface and the third surface may face each other, and the metal film does not need to be formed in a region of the second surface overlapping the first metal region of the metal film on the first flap.

In another exemplary, the base material may include: a third surface continuous with the first surface on an opposite side from the first flap, and a fourth surface positioned between the second surface and the third surface, the fourth surface continuous with each of the second surface and the third surface. In an assembled state, the second surface and the third surface may face each other, and the metal film does not need to be formed in a region of the second surface overlapping the second metal region of the metal film on the first flap.

In another exemplary, the first flap may be a tuck flap. Accordingly, in the container, the RFID module disposed on the tuck flap continuous with the first surface is disposed between the tuck flap and the side surface, and thus, does not appear on the outer surface of the container. Therefore, the designability of the container can be improved.

In another exemplary, the first flap may include: a main body flap connected to the first surface, and an extending flap extending from the main body flap. The first metal region may be disposed on the main body flap. The second metal region may be disposed on the extending flap. Accordingly, even when the size of the container is small, reduction in the communication distance can be suppressed.

In another exemplary, when the metal film is irradiated with the electromagnetic wave at the communication frequency, a current may flow in a direction intersecting the slit. As described above, since the metal film functions as a dipole antenna, communication characteristics as a dipole antenna can be obtained.

In another exemplary, the filter circuit may be an LC parallel resonance circuit. Accordingly, a current at a frequency matching the RFIC can be flowed through the RFIC.

In another exemplary, the sheet resistance of the metal film may be 0.5 Ω/□ or more. Even with this configuration, since the RFID module includes the filter circuit, it can be flowed through the RFIC using the eddy current generated in the metal film.

In another exemplary, the thickness of the metal film may be 10 Å (=1 nm) or more and 1 μm or less. Even with this configuration, since the RFID module includes the filter circuit, it can be flowed through the RFIC using the eddy current generated in the metal film.

It is noted that each of the exemplary embodiments described below shows a specific example of the present invention, and the present invention is not limited to this configuration. In addition, numerical values, shapes, configurations, steps, order of steps, and the like specifically shown in the following embodiments show examples, and do not limit the present invention. Among the constituent elements in the following embodiments, constituent elements that are not described in independent claims indicating the highest concept are described as optional constituent elements. In addition, in all the embodiments, the configurations in the respective modifications are the same, and the configurations described in the respective modifications may be combined.

When the relative dielectric constant εr>1, the electrical lengths of the antenna pattern and the conductor pattern become longer than the physical length. In the present specification, the electrical length is a length in consideration of shortening or extension of a wavelength due to a relative dielectric constant or a parasitic reactance component.

### First Exemplary Embodiment

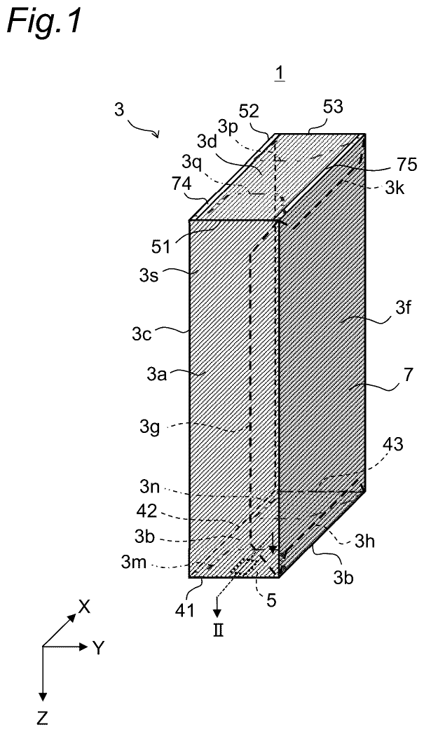

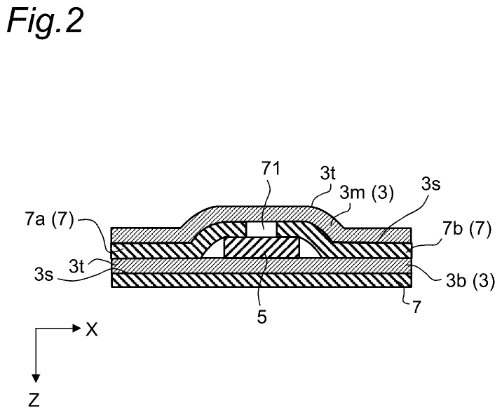

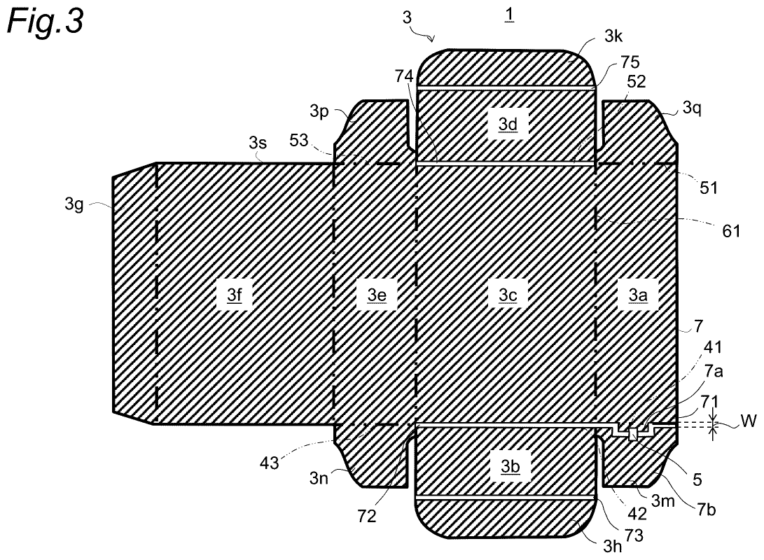

Next, a schematic configuration of a container 1 including an RFID module 5 according to the present invention will be described. FIG. 1 is an overall perspective view of a container 1 including an RFID module 5 according to a first exemplary embodiment. FIG. 2 is a cross-sectional view taken along line II in FIG. 1, and FIG. 3 is a developed view of the container 1 in FIG. 1.

According to an exemplary aspect, the container 1 includes a base material 3, an RFID module 5 attached to the base material 3, a metal film 7 formed on a first main surface 3s of the base material 3, and a first slit 71 that divides the metal film 7.

The container 1 is formed into a three-dimensional shape by assembling a planar base material 3 as shown in FIG. 3, for example. The container 1 has, for example, a rectangular parallelepiped shape, and the base material 3 is made of, for example, paper, resin, or plastic.

The base material 3 includes a first surface 3a, a second surface 3b, a third surface 3c, a fourth surface 3d, a fifth surface 3e, a sixth surface 3f, a joining flap 3g, a first tuck flap 3h, a second tuck flap 3k, a first dust flap 3m, a second dust flap 3n, a third dust flap 3p, and a fourth dust flap 3q. For example, the first surface 3a, the third surface 3c, the fifth surface 3e, and the sixth surface 3f become side surfaces of the container 1 when assembled. The fourth surface 3d becomes an upper surface (e.g., a top surface) of the container 1 when assembled, and the second surface 3b becomes a lower surface (e.g., a bottom surface) of the container 1 when assembled. When assembled, the first surface 3a and the fifth surface 3e face each other, and the third surface 3c and the sixth surface 3f face each other. The first main surface 3s of the base material 3 is a surface mainly to be an outer surface (e.g., a front surface) of the container 1, and the second main surface 3t of the base material 3 is a surface mainly to be an inner surface (e.g., a back surface) of the container 1.

The first main surface 3s of the joining flap 3g is attached to the second main surface 3t of the first surface 3a through the adhesive layer when assembled, for example. The first main surface 3s of the first tuck flap 3h comes into contact with the second main surface 3t of the sixth surface 3f when assembled. The first main surface 3s of the second tuck flap 3k comes into contact with the second main surface 3t of the sixth surface 3f when assembled.

Each of the first dust flap 3m and the second dust flap 3n prevents dust or the like from entering the inside of the container 1 through a gap between the second surface 3b serving as a lower surface and the first surface 3a and fifth surface 3e serving as side surfaces. Similarly, each of the third dust flap 3p and the fourth dust flap 3q prevents dust or the like from entering the inside of the container 1 through a gap between the fourth surface 3d serving as an upper surface and the first surface 3a and fifth surface 3e serving as side surfaces.

The first surface 3a is connected to the first dust flap 3m through the lower side 41, and is connected to the fourth dust flap 3q through the upper side 51. The first slit 71 extends from the end portion along the lower side 41 that is the boundary between the first surface 3a and the first dust flap 3m, bends in an S shape toward the first dust flap 3m in a direction away from the lower side 41 when approaching the central portion of the lower side 41, further extends in a direction parallel to the lower side 41, bends in an S shape in a direction toward the lower side 41 when passing the central portion of the lower side 41, and extends again along the lower side 41. The first surface 3a and the third surface 3c are connected through a side 61.

The third surface 3c is connected to the second surface 3b through the lower side 42, and is connected to the fourth surface 3d through the upper side 52. Moreover, a second slit 72 is formed in the metal film 7 along the lower side 42 to divide the metal film 7 on the second surface 3b and the metal film 7 on the third surface 3c. Similarly, a fourth slit 74 is formed in the metal film 7 along the upper side 52 to divide the metal film 7 on the third surface 3c and the metal film 7 on the fourth surface 3d. In the developed view of the container 1, the second slit 72 is positioned on the extension of the first slit 71.

The second surface 3b is connected to the first tuck flap 3h on the side opposite to the third surface 3c. A third slit 73 is formed in the metal film 7 between the second surface 3b and the first tuck flap 3h to divide the metal film 7 on the second surface 3b and the metal film 7 on the first tuck flap 3h.

The fourth surface 3d is connected to the second tuck flap 3k on the side opposite to the third surface 3c. A fifth slit 75 is formed in the metal film 7 between the fourth surface 3d and the second tuck flap 3k to divide the metal film 7 on the fourth surface 3d and the metal film 7 on the second tuck flap 3k.

The third surface 3c is connected to the fifth surface 3e on the side opposite to the first surface 3a. The fifth surface 3e is connected to the second dust flap 3n through the lower side 43, and is connected to the third dust flap 3p through the upper side 53. The fifth surface 3e is connected to the sixth surface 3f on the side opposite to the third surface 3c. The sixth surface 3f is connected to the joining flap 3g on the side opposite to the fifth surface 3e.

According to the exemplary aspect, the metal film 7 is formed on the entire surface of the first main surface 3s of the base material 3 except for the first to fifth slits 71 to 75. In this aspect, each of the first to fifth slits 71 to 75 can be a groove (or channel) that divides the metal film 7. Moreover, the metal film 7 is made of a film body of a conductive material of a metal foil, such as an aluminum foil or a copper foil, and is formed by attaching a metal sheet, for example. By using a metal having a small resistance value such as aluminum or copper as the metal film 7, a communication distance is increased. The thickness of the metal film 7 is, for example, more than 5 μm and 40 μm or less.

The metal film 7 on the first dust flap 3m is physically divided into two regions by the first slit 71. In the first embodiment, the metal film 7 on the first dust flap 3m is divided into two regions of a first metal region 7a and a second metal region 7b, and the first metal region 7a and the second metal region 7b are electrically insulated by the first slit 71. It is noted that the metal film 7 does not need to be formed on the entire surface of the base material 3, and may be partially formed on the first dust flap 3m and another surface in alternative exemplary aspects.

In operation, the metal film 7 is configured to function as a dipole antenna by a first metal region 7a extending along the outside of the container 1 in a direction intersecting the first slit 71 and a second metal region 7b extending along the outside of the container 1 in a direction opposite to the first metal region 7a in the direction intersecting the first slit 71. When the container 1 is irradiated with the electromagnetic wave at the communication frequency, in the first dust flap 3m, resonance occurs with the communication frequency in a direction intersecting the first slit 71, for example, a direction orthogonal to the first slit 71, and a current flows.

As described above, the first slit 71 is a groove that divides the metal film 7 on the first dust flap 3m. In addition, the first slit 71 also divides the metal film 7 in the second metal region 7b of the first dust flap 3m and the metal film 7 on the first surface 3a. The width W of the first slit 71 is, for example, 1 mm. The first slit 71 may be formed by shaving the metal film 7 after forming the metal film 7 on the entire first main surface 3s of the base material 3, or may be formed by attaching two metal sheets to the first main surface 3s of the base material 3 with a width W of the first slit 71 spaced apart.

According to an exemplary embodiment, the RFID module 5 is a wireless communication device configured to perform wireless communication (e.g., transmission and reception) using a high-frequency signal at a communication frequency (e.g., a carrier frequency). The RFID module 5 is configured to wirelessly communicate using a high-frequency signal at a frequency for communication in the UHF band, for example. For purposes of this disclosure, the UHF band is a frequency band of 860 MHz to 960 MHz.

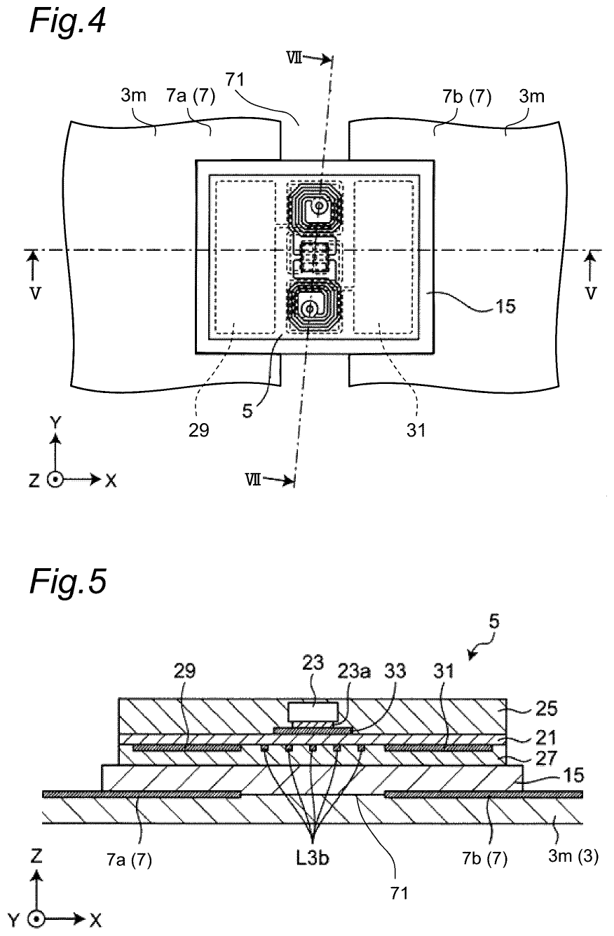

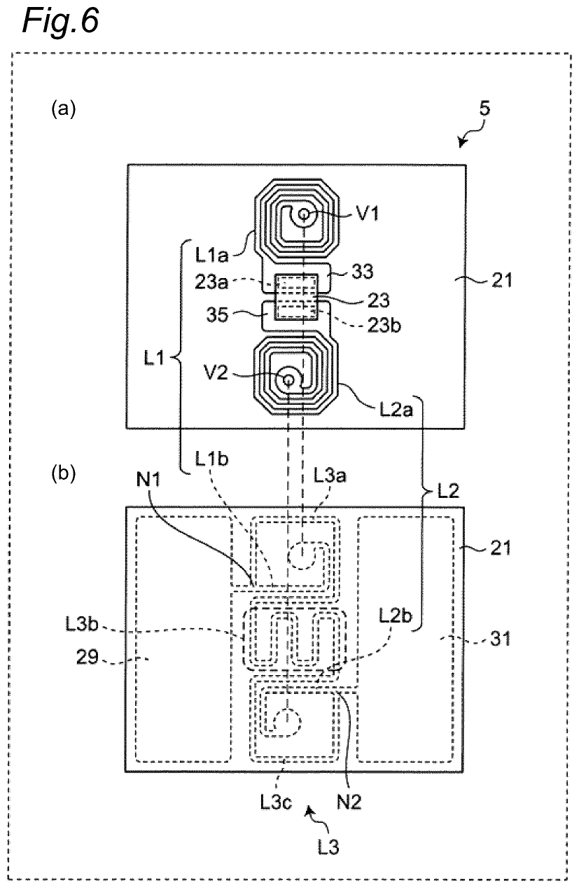

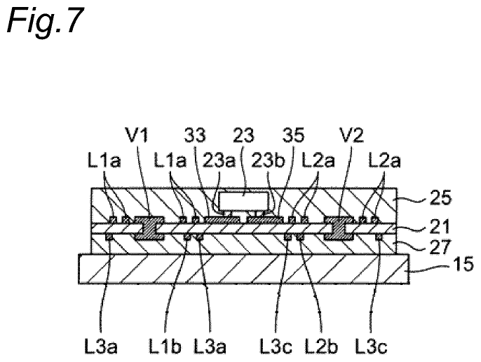

Next, a configuration of the RFID module 5 will be described with reference to FIGS. 4 to 7. FIG. 4 is a perspective plan view of the RFID module, and FIG. 5 is a cross-sectional view taken along line indicated by arrows V in FIG. 4. FIG. 6 shows a plan view of a conductor pattern formed on a substrate of the RFID module, where(a) is a plan view of a conductor pattern formed on an upper surface of the substrate of the RFID module, and(b) is a perspective plan view of a conductor pattern formed on a lower surface of the substrate as viewed from above. FIG. 7 is a cross-sectional view taken along line indicated by arrows VII in FIG. 4. It is noted that in the drawings, the X-Y-Z coordinate system facilitates understanding of the invention and does not limit the invention. The X-axis direction indicates a longitudinal direction of the RFID module 5, the Y-axis direction indicates a depth (e.g., a width) direction, and the Z-axis direction indicates a thickness direction. The X, Y, and Z directions are orthogonal to one another.

As shown in FIG. 4, the RFID module 5 is bonded to the upper surface of each of the first metal region 7a and the second metal region 7b of the metal film 7 through an adhesive layer 15 such as a double-sided tape or a synthetic resin.

As shown in FIG. 5, the RFID module 5 includes a substrate 21 and an RFIC 23 mounted on the substrate 21. The substrate 21 is, for example, a flexible substrate such as polyimide. A protective film 25 is formed on the upper surface of the substrate 21 on which the RFIC 23 is mounted and can be, for example, an elastomer such as polyurethane or a hot melt agent such as ethylene vinyl acetate (EVA). A protection film 27 is also attached to the lower surface of the substrate 21. The protection film 27 is, for example, a cover lay film such as a polyimide film (Kapton tape).

Referring to FIG. 6, on the upper surface of the substrate 21, a third electrode 33, a fourth electrode 35, a conductor pattern L1a of the main portion of a first inductance element L1, and a conductor pattern L2a of the main portion of the second inductance element L2 are formed. The third electrode 33 is connected to one end of the conductor pattern L1a, and the fourth electrode 35 is connected to one end of the conductor pattern L2a. These conductor patterns are obtained by patterning a copper foil by photolithography, for example.

On the lower surface of the substrate 21, a first electrode 29 and a second electrode 31 respectively capacitively coupled to the first metal region 7a and the second metal region 7b of the metal film 7 are formed. In addition, on the lower surface of the substrate 21, a conductor patterns L1b of a part of the first inductance element L1, and conductor patterns L3a, L3b (e.g., the conductor pattern surrounded by two-dot chain lines), and L3c of the third inductance element L3 are formed. These conductor patterns are also obtained by patterning a copper foil by photolithography, for example.

One end of the conductor pattern L1b of a part of the first inductance element L1 and one end of the conductor pattern L3a of the third inductance element L3 are connected to the first electrode 29. Similarly, one end of the conductor pattern L2b of the second inductance element L2 and one end of the conductor pattern L3c of the third inductance element L3 are connected to the second electrode 31. A conductor pattern L3b is connected between the other end of the conductor pattern L3a of the third inductance element L3 and the other end of the conductor pattern L3c.

The other end of the conductor pattern L1b of the first inductance element L1 and the other end of the conductor pattern L1a of the first inductance element L1 are connected through the via conductor V1. Similarly, the other end of the conductor pattern L2b of the second inductance element L2 and the other end of the conductor pattern L2a of the second inductance element L2 are connected through the via conductor V2.

As further shown, the RFIC 23 is mounted on the third electrode 33 and the fourth electrode 35 on the upper surface of the substrate 21. That is, the terminal 23a of the RFIC 23 is connected to the third electrode 33, and the terminal 23b of the RFIC 23 is connected to the fourth electrode 35.

According to the exemplary aspect, the first inductance element L1 and the conductor pattern L3a of the third inductance element L3 are each formed in different layers of the substrate 21, and are arranged in a relationship in which the respective coil openings overlap each other. Similarly, the second inductance element L2 and the conductor pattern L3c of the third inductance element L3 are each formed in different layers of the substrate 21, and are arranged in a relationship in which the respective coil openings overlap each other. Furthermore, the RFIC 23 is positioned between the second inductance element L2 and the conductor pattern L3c of the third inductance element L3, and the first inductance element L1 and the conductor pattern L3a of the third inductance element L3 on the surface of the substrate 21.

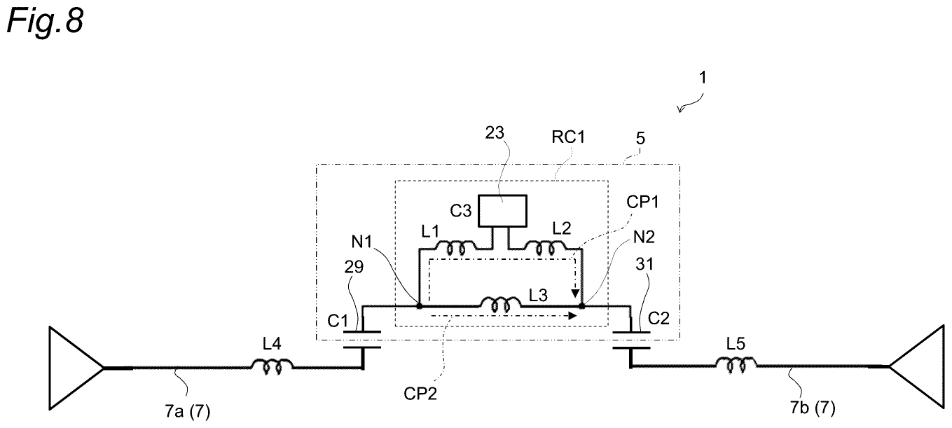

Next, a circuit configuration of the RFID module 5 will be described with reference to FIG. 8. FIG. 8 is a circuit diagram of the RFID module 5.

In the RFID module 5, a first current path CP1 passing through the upper surface and the lower surface of the substrate 21 and a second current path CP2 passing through the lower surface of the substrate 21 are formed. The first current path CP1 reaches the second electrode 31 from the first electrode 29 through the branch point N1, the conductor pattern L1b, the conductor pattern L1a, the RFIC 23, the conductor pattern L2a, the conductor pattern L2b, and the branch point N2. The second current path CP2 reaches the second electrode 31 from the first electrode 29 through the branch point N1, the conductor pattern L3a, the conductor pattern L3b, the conductor pattern L3c, and the branch point N2. Here, the winding directions of the currents flowing through the first inductance element L1 including the conductor pattern L1b connected to the conductor pattern L1a through the via conductor V1 and the second inductance element L2 including the conductor pattern L2b connected to the conductor pattern L2a through the via conductor V2 are reverse to each other, and the magnetic field generated by the first inductance element L1 and the magnetic field generated by the second inductance element L2 cancel each other. Moreover, the first current path CP1 and the second current path CP2 are each formed in parallel with each other between the first electrode 29 and the second electrode 31.

In the RFID module 5, since the first current path CP1 is a part of the parallel resonance circuit RC1 being the LC parallel resonance circuit and matches the radio wave at the communication frequency, when the metal film 7 receives the radio wave at the communication frequency, a current will flow through the RFIC 23.

In the RFID module 5, a parallel resonance circuit RC1 is formed based on the configuration. The parallel resonance circuit RC1 is a loop circuit including the first inductance element L1, the RFIC 23, the second inductance element L2, and the third inductance element L3.

The capacitor C1 includes the first metal region 7a, the first electrode 29, the adhesive layer 15, and the protection film 27. The capacitor C2 includes the second metal region 7b, the second electrode 31, the adhesive layer 15, and the protection film 27. The fourth inductance element L4 is an inductance component of the first metal region 7a of the first dust flap 3m, the metal film 7 on the first surface 3a electrically connected to the first metal region 7a, and the metal film 7 on the third surface, and the fifth inductance element L5 is an inductance component of the second metal region 7b of the first dust flap 3m and the metal film 7 on the second surface 3b capacitively coupled to the second metal region 7b.

The parallel resonance circuit RC1 is designed to perform LC parallel resonance by impedance matching with respect to a radio wave at the communication frequency. Accordingly, matching with the RFIC is achieved at the communication frequency, and the communication distance of the RFID module 5 at the communication frequency can be secured.

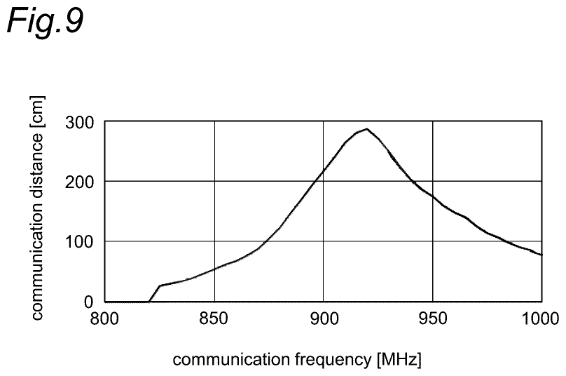

FIG. 9 is a graph showing communication characteristics of the container 1 including the RFID module 5 in the first exemplary embodiment. In particular, the communication characteristics of the container 1 provided with the RFID module 5 are good because the container 1 has a communication distance of about 70 cm or more even in the UHF band of 860 MHz to 960 MHz, and particularly has a communication distance of 250 cm or more near 920 MHz.

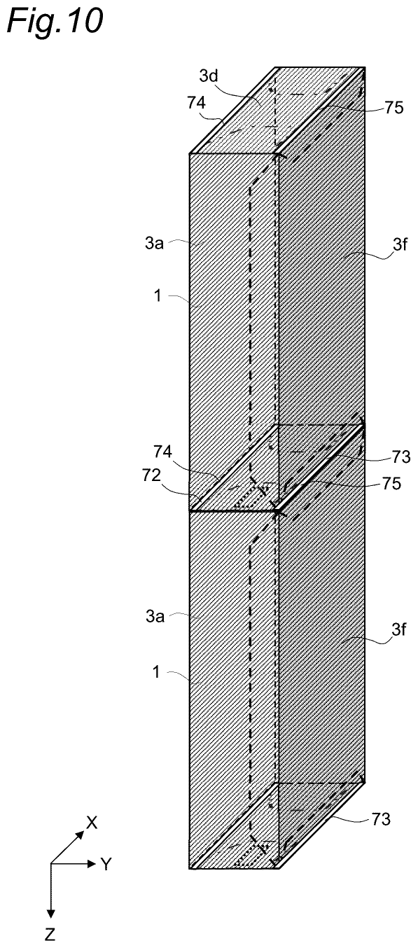

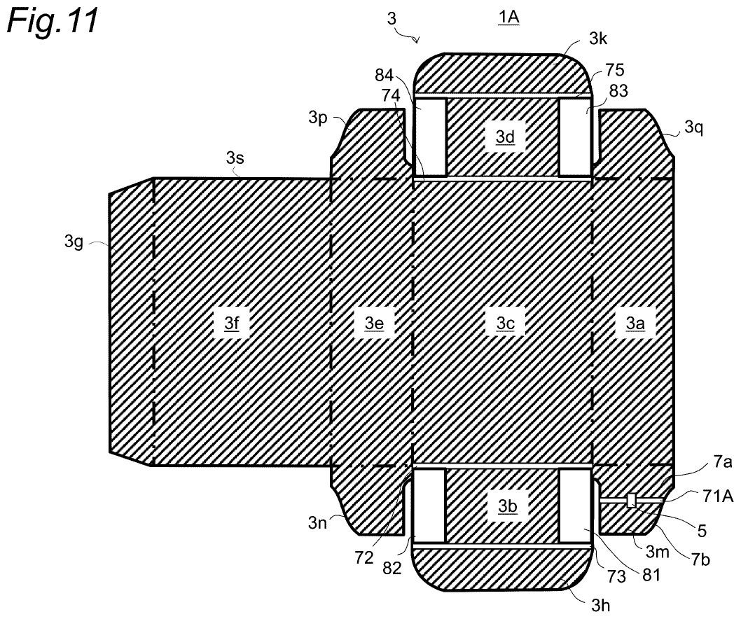

In the container 1 of the first exemplary embodiment, the fourth slit 74 is formed between the fourth surface 3d and the third surface 3c, and the fifth slit 75 is formed between the fourth surface 3d and the second tuck flap 3k. Due to this configuration, the metal film 7 on the fourth surface 3d is not electrically directly connected to the third surface 3c and the second tuck flap 3k. Accordingly, as shown in FIG. 10, when a plurality of containers 1 are arranged in the vertical direction, even when the fourth surface 3d of the lower container 1 and the second surface 3b of the upper container 1 are capacitively coupled and the fourth surface 3d of the lower container 1 and the second surface 3b of the upper container 1 have the same potential, the influence on the potentials of the first surface 3a and the third surface 3c of the upper container 1 can be reduced. Therefore, in the first metal region 7a and the second metal region 7b of the metal film 7 of each container 1, since the insulation state is maintained unless passing through the RFID module 5, communication with a plurality of containers 1 can be performed at a time.

As described above, the container 1 of the first embodiment is an assembled box-shaped container 1 including the RFID module 5, and includes the insulating base material 3 forming the outer shape of the container 1, the metal film 7 formed on the base material 3, and the first slit 71 formed in the metal film 7. The base material 3 has a first surface 3a serving as a side surface of the container 1, a second surface 3b serving as a lower surface, and a first dust flap 3m continuous with the first surface 3a. Moreover, the first slit 71 separates the metal film 7 on the first dust flap 3m into the first metal region 7a and the second metal region 7b. The RFID module 5 includes an RFIC 23, a parallel resonance circuit RC1 as a filter circuit that transmits, to the RFIC 23, a current due to an electromagnetic wave at a natural resonance frequency being a communication frequency, and first and second electrodes 29 and 31 connected to the parallel resonance circuit RC1. The first electrode 29 of the RFID module 5 is electrically connected to the first metal region 7a of the metal film 7 on the first dust flap 3m, and the second electrode 31 of the RFID module 5 is electrically connected to the second metal region 7b of the metal film 7 on the first dust flap 3m. The first metal region 7a of the metal film 7 on the first dust flap 3m is continuous with the metal film 7 on the first surface 3a, and in the assembled state, the second metal region 7b of the metal film 7 on the first dust flap 3m is electrically connected to the metal film 7 on the second surface 3b by capacitive coupling.

As further described above, the RFID module 5 is disposed across the first slit 71 that divides the metal film 7 formed on the first dust flap 3m of the container 1 into the first metal region 7a and the second metal region 7b. The first metal region 7a of the first dust flap 3m is continuous with the metal film 7 on the first surface 3a, and the second metal region 7b is capacitively coupled to the metal film 7 on the second surface. Therefore, each of the first and second metal regions 7a and 7b can be configured as an antenna electrode, and a current can flow through the RFIC 23 by series resonance. As a result, even in the case of a container 1 on which the metal film 7 is formed, a container 1 having the RFID module 5 can be provided that is configured to perform wireless communication with improved designability.

In addition, in the container 1, the RFID module 5 disposed on the first dust flap 3m continuous with the first surface 3a does not appear on the outer surface of the container 1 because the RFID module 5 is positioned inside the second surface 3b in the assembled state of the container 1. Therefore, the designability of the container 1 can also be maintained or improved.

In addition, the container 1 of the first embodiment can be provided at a lower cost than a container to which a conventional metal-compatible RFID module is attached. In addition, when the conventional flag type RFID module protrudes from the container and is broken, communication characteristics deteriorate. Furthermore, since the RFID module has to protrude from the container, the degree of freedom of designability is reduced. However, if the container 1 of the embodiment is used, since the RFID module does not need to protrude from the container, the degree of freedom of designability can be prevented from being reduced.

Tas also described above, the container 1 includes a second slit 72 that divides the metal film 7 on the third surface 3c continuous with the metal film 7 on the first surface 3a and the metal film 7 on the second surface 3b. Therefore, the second slit 72 electrically divides the metal film 7 on the first surface 3a and the metal film 7 on the second surface 3b. Accordingly, communication characteristics are improved.

The base material 3 has a third surface 3c continuous with each of the first surface 3a and the second surface 3b. The second slit 72 is formed between the metal film 7 on the second surface 3b and the metal film 7 on the third surface 3c. Accordingly, the metal film 7 on the third surface 3c can be connected to the first metal region 7a, and the communication distance is extended.

The base material 3 includes a first tuck flap 3h continuous with the second surface 3b, on the opposite side from the third surface 3c with respect to the second surface 3b, and includes a third slit 73 formed between the metal film 7 on the second surface 3b and the metal film 7 on the first tuck flap 3h. Accordingly, the metal film 7 on the second surface 3b can be prevented from being electrically conducted with the metal film 7 on the sixth surface 3f capacitively coupled to the metal film 7 on the first tuck flap 3h, and it is possible to suppress deterioration in communication characteristics. In addition, in the assembled state of the container 1, as shown in FIG. 2, the metal film 7 in the second metal region 7b on the first dust flap 3m overlaps the metal film 7 on the second surface 3b with interposition of the base material 3, and thus, is capacitively coupled to the metal film 7 on the second surface 3b. Accordingly, the metal film 7 on the second surface 3b can be configured to function as a booster electrode of the first dust flap 3m, and the reading distance is improved. It is noted that the first dust flap 3m and the second surface 3b may be bonded by an adhesive layer. For example, by bonding the metal film 7 formed on the first dust flap 3m and the second surface 3b, even when the container 1 is turned upside down, capacitive coupling between the metal film 7 in the second metal region 7b on the first dust flap 3m and the metal film 7 on the second surface 3b can be maintained, so that deterioration in communication characteristics can be suppressed.

Moreover, the metal film 7 may be formed on the entire surface of the base material 3 except for the first slit 71, the second slit 72, and the third slit 73. As described above, a design in which a metal film 7 is formed on almost the entire surface of the first main surface 3s of the container 1 can also be achieved.

When the metal film 7 is irradiated with the electromagnetic wave at the communication frequency, a current flows in a direction intersecting the first slit 71. As described above, since the metal film 7 functions as a dipole antenna, communication characteristics as a dipole antenna can be obtained.

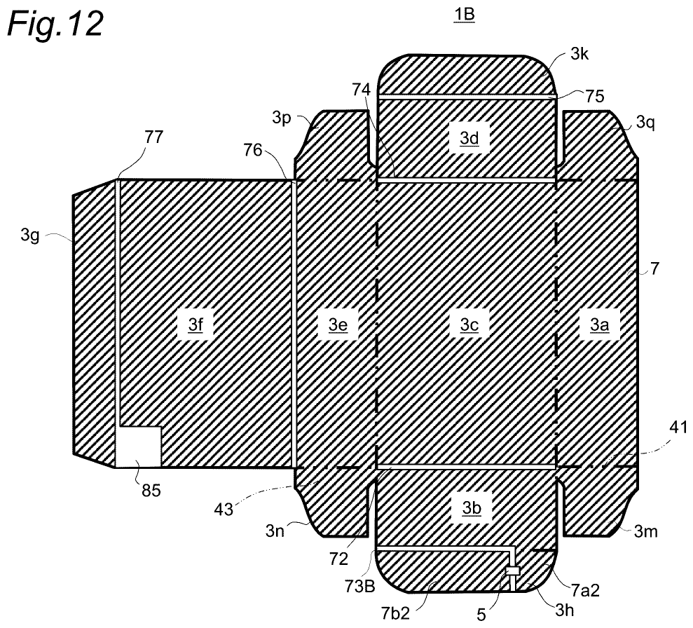

Next, a first modification of the first exemplary embodiment will be described with reference to FIG. 11. FIG. 11 is a developed view of a container 1A in the first modification of the first exemplary embodiment. As shown, the container 1A has a configuration in which the first slit 71 of the container 1 of the first embodiment is shifted in the tip direction of the first dust flap 3m. The configuration other than this feature and the points described below is substantially the same as that of the container 1 of the first embodiment.

In the container 1A in the first modification, the first slit 71A is formed so as to cross the central portion of the first dust flap 3m, for example. Therefore, since the area of the first metal region 7a in the first dust flap 3m is increased, in order to prevent the first metal region 7a from being capacitively coupled to the metal film 7 on the second surface 3b, a non-metal region 81 is formed in a region overlapping the first metal region 7a on the second surface 3b in the assembled state of the container 1A. In the non-metal region 81, the front surface of the base material 3 may be exposed, or the base material 3 may be coated with a non-metal material. Accordingly, the container 1A in the first modification can communicate as with the container 1 of the first embodiment.

In addition, a non-metal region 82 may be formed symmetrically with the non-metal region 81 on the second surface 3b. Furthermore, on the fourth surface 3d, in the assembled state, a non-metal region 83 may be formed at a position facing the non-metal region 81, and a non-metal region 84 may be formed at a position facing the non-metal region 82. Accordingly, the designability is improved, and when the containers 1A are stacked in the vertical direction, the non-metal regions overlap each other even when the containers 1A are rotated by 180 degrees, so that a current can be prevented from flowing between the upper and lower containers 1A and to perform wireless communication collectively.

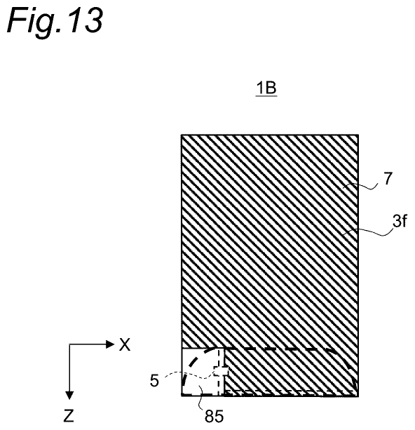

Next, a second modification of the first exemplary embodiment will be described with reference to FIGS. 12 and 13. FIG. 12 is a developed view of a container 1B in the second modification of the first exemplary embodiment. FIG. 13 is a front view of a sixth surface 3f of the assembled container 1B.

The container 1B in the second modification of the first embodiment has a configuration in which the RFID module 5 and the first slit 71 are arranged in the first tuck flap 3h instead of the first dust flap 3m in the container 1 of the first embodiment. The configuration other than this feature and the points described below is substantially the same as that of the container 1 of the first embodiment.

In the container 1B, there is no slit in the first dust flap 3m. The third slit 73B formed between the metal film 7 on the second surface 3b and the metal film 7 on the first tuck flap 3h is bent toward the tip of the first tuck flap 3h. Therefore, the metal film 7 on the first tuck flap 3h is divided into the first metal region 7a2 and the second metal region 7b2 by the third slit 73B. Moreover, the first metal region 7a2 is continuous with the metal film 7 on the second surface 3b. The second metal region 7b2 overlaps the metal film 7 on the sixth surface 3f in the assembled state, and thus, is capacitively coupled to the metal film 7 on the sixth surface 3f.

As further shown, a sixth slit 76 is formed along the side between the metal film 7 on the fifth surface 3e and the metal film 7 on the sixth surface 3f. In addition, a seventh slit 77 is formed along the side between the metal film 7 on the sixth surface 3f and the metal film 7 on the joining flap 3g. Accordingly, in the assembled state, even when the first tuck flap 3h overlaps the sixth surface 3f and the second metal region 7b2 and the metal film 7 on the sixth surface 3f are capacitively coupled, it is possible to reduce the potential of the metal film 7 on the sixth surface 3f from being affected by the potential of the metal film 7 on the fifth surface 3e and the potential of the metal film 7 on the joining flap 3g. Therefore, the metal film 7 on the sixth surface 3f can be configured as an antenna element.

In order to prevent the first metal region 7a2 of the first tuck flap 3h from being capacitively coupled to the metal film 7 on the sixth surface 3f, in a state where the container 1B is assembled, a non-metal region 85 is formed in a region overlapping the first metal region 7a2 on the sixth surface 3f. The non-metal region 85 is connected to the seventh slit 77. In the non-metal region 85, the front surface of the base material 3 may be exposed, or the base material 3 may be coated with a non-metal material.

As described above, the base material 3 includes the third surface 3c continuous with the second surface 3b as the first surface on the opposite side from the first tuck flap 3h as the first flap, the fifth surface 3e as the fourth surface positioned between the sixth surface 3f as the second surface and the third surface 3c and continuous with each of the sixth surface 3f and the third surface 3c, and the joining flap 3g continuous with the sixth surface 3f on the opposite side from the fifth surface 3e. A sixth slit 76 as a second slit is formed between the metal film 7 on the sixth surface 3f and the metal film 7 on the fifth surface 3e. Between the metal film 7 on the sixth surface 3f and the metal film 7 on the joining flap 3g, a seventh slit 77 as a third slit that separates each metal film 7 is formed. In the assembled state, the sixth surface 3f and the third surface 3c face each other, and a metal film 7 is not formed in the non-metal region 85 on the sixth surface 3f overlapping the first metal region 7a2 of the metal film 7 on the first tuck flap 3h.

Even with this configuration, communication can be made as in the container 1 of the first embodiment. In addition, since the RFID module 5 is disposed on the first tuck flap 3h, the RFID module 5 is positioned inside the sixth surface 3f in the assembled state, and thus does not appear on the outer surface of the container 1. Therefore, the designability of the container 1 can be maintained or improved.

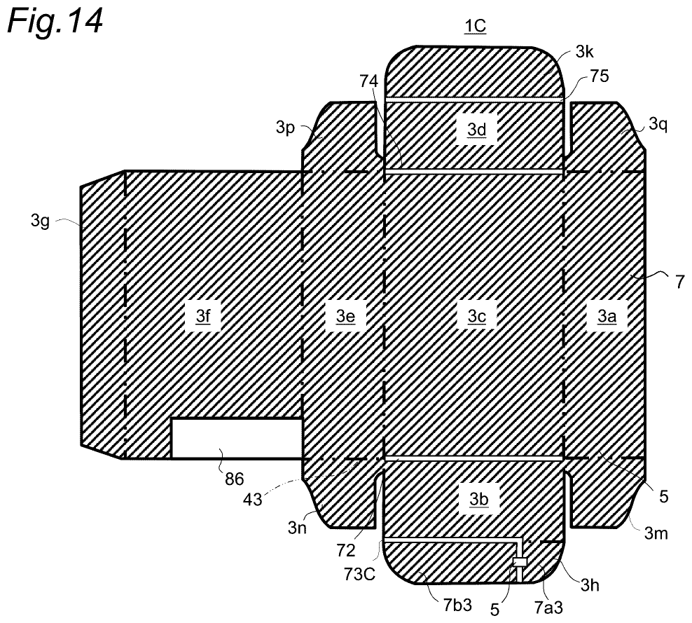

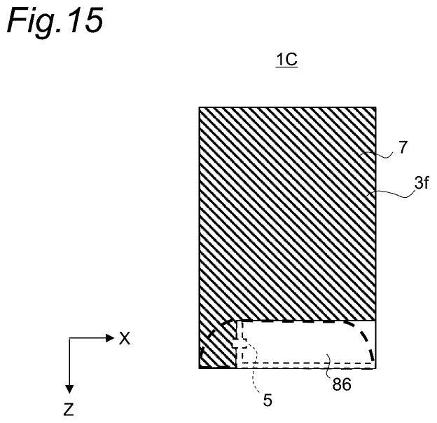

Next, a third modification of the first exemplary embodiment will be described with reference to FIGS. 14 and 15. FIG. 14 is a developed view of a container 1C in the third modification of the first embodiment. FIG. 15 is a front view of a sixth surface 3f of the assembled container 1C.

The container 1C in the third modification of the first embodiment has a configuration in which the first metal region 7a2 is capacitively coupled to the sixth surface 3f in the container 1B of the second modification of the first embodiment. The configuration other than this point and the points described below is substantially the same as that of the container 1B of the second modification of the first embodiment.

The metal film 7 on the first tuck flap 3h is divided into the first metal region 7a3 and the second metal region 7b3 by the slit 73C. The first metal region 7a3 is continuous with the metal film 7 on the second surface 3b. The first metal region 7a3 overlaps the metal film 7 on the sixth surface 3f in the assembled state, and thus, is capacitively coupled to the metal film 7 on the sixth surface 3f.

In order to prevent the second metal region 7b3 of the first tuck flap 3h from being capacitively coupled to the metal film 7 on the sixth surface 3f, when the container 1C is assembled, a non-metal region 86 is formed in a region overlapping the second metal region 7b3 on the sixth surface 3f. In the non-metal region 86, the front surface of the base material 3 may be exposed, or the base material 3 may be coated with a non-metal material.

As described above, the base material 3 includes the third surface 3c continuous with the second surface 3b as the first surface on the opposite side from the first tuck flap 3h as the first flap and the fifth surface 3e as the fourth surface positioned between the sixth surface 3f as the second surface and the third surface 3c and continuous with each of the sixth surface 3f and the third surface 3c. In the assembled state, the sixth surface 3f and the third surface 3c face each other, and a metal film 7 is not formed in the non-metal region 86 on the sixth surface 3f overlapping the second metal region 7b3 of the metal film 7 on the first tuck flap 3h.

Even with this configuration, communication can be made as in the container 1 of the first embodiment. In addition, since the RFID module 5 is disposed on the first tuck flap 3h, the RFID module 5 is positioned inside the sixth surface 3f in the assembled state of the container 1C, and thus does not appear on the outer surface of the container 1. Therefore, the designability of the container 1 can be maintained or improved.

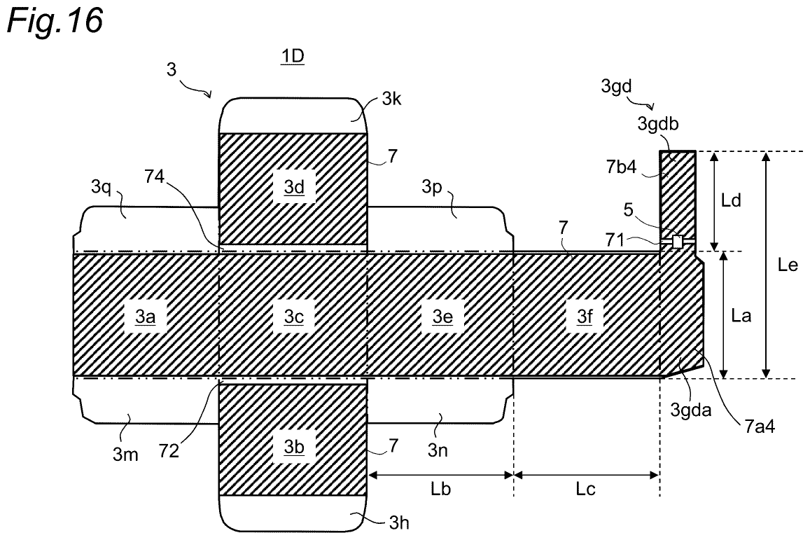

Next, a fourth modification of the first exemplary embodiment will be described with reference to FIG. 16. FIG. 16 is a developed view of a container 1D in the third modification of the first embodiment.

The container 1D in the fourth modification of the first embodiment has a configuration in which the RFID module 5 is disposed on the extending flap 3gdb extending from the main body flap 3gda of the joining flap 3gd, instead of the RFID module 5 being disposed on the first dust flap 3m in the container 1 of the first embodiment. The configuration other than this feature and the points described below is substantially the same as that of the container 1 of the first embodiment.

The joining flap 3gd of the container 1D includes a main body flap 3gda and an extending flap 3gdb extending from the main body flap 3gda. The main body flap 3gda corresponds to the joining flap 3g of the first embodiment. The first metal region 7a4 is disposed on the main body flap 3gda. When the container 1D is assembled, the extending flap 3gdb is bent along a connection line with the joining flap 3ga and disposed so as to overlap the inside of the fourth surface 3d. A metal film 7 is formed on the extending flap 3gdb, and a second metal region 7b4 is disposed thereon. In the extending flap 3gdb, the first slit 71 is formed on the joining flap 3ga side.

In the fourth modification, the metal film 7 is not formed on the first main surface 3s of each of the first tuck flap 3h, the second tuck flap 3k, and the first dust flap 3m to the fourth dust flap 3q. Since these flaps are not exposed to the outside in a state where the container 1D is assembled, the designability is not impaired even when the metal film 7 is not formed. In addition, the cost can be reduced by not forming the metal film 7 on these flaps.

The metal films 7 formed on the first surface 3a, the third surface 3c, the fifth surface 3e, the sixth surface 3f, and the main body flap 3gda of the joining flap 3gd are continuous and conductive. A second slit 72 is formed between the second surface 3b and the third surface 3c, and a fourth slit 74 is formed between the fourth surface 3d and the third surface 3c. Therefore, the metal films 7 formed on the respective second surface 3b and third surface 3c are divided and not conducted to each other. In addition, the metal films 7 formed on the respective fourth surface 3d and third surface 3c are also divided and not conducted to each other.

When the height La of the side between the second dust flap 3n and the fourth dust flap 3q on the fifth surface 3e is, for example, 5 cm, and the lateral lengths Lb and Lc of the respective fifth surface 3e and sixth surface 3f are, for example, 6 cm, since the height of the container 1D is low, the communication distance is shortened with the length of the metal film 7 on the side surface of the container 1D. Even if a slit is formed in any one of the flaps, the height of the flap can be only half the length of each of the vertical and horizontal lengths of the side surface. Therefore, in this case, the flap can be extended only by 3 cm at the maximum.

On the other hand, when the extending flap 3gdb is used, since the length Le of the metal film 7 can be the same as the length Lc of the fourth surface 3d and the sixth surface 3f, the metal film 7 can be extended by up to 6 cm as an antenna electrode. Accordingly, the length Lc can be secured up to about 11 cm at maximum together with the metal film 7 on the joining flap 3ga, and the communication distance can be improved.

As described above, the base material 3 has the sixth surface 3f as the first surface and the fourth surface 3d as the second surface, which serve as any of the side surface, the top surface, and the bottom surface of the container 1D, and the joining flap 3gd as the first flap continuous with the sixth surface 3f. The first slit 71 is formed so as to separate the metal film 7 on the joining flap 3gd into the first metal region 7a4 and the second metal region 7b4. The first electrode 29 of the RFID module 5 is electrically connected to the first metal region 7a4 of the metal film 7 on the joining flap 3gd, and the second electrode 31 of the RFID module 5 is electrically connected to the second metal region 7b4 of the metal film 7 on the joining flap 3gd. The first metal region 7a4 of the metal film 7 on the joining flap 3gd is continuous with the metal film 7 on the sixth surface 3f, and in the assembled state, the second metal region 7b4 on the extending flap 3gdb of the joining flap 3gd is electrically connected to the metal film 7 on the fourth surface 3d by capacitive coupling. Even with this configuration, communication can be made as in the container 1 of the first embodiment.

At the time of assembling the container 1, by applying an adhesive layer to the back side of the first surface 3a facing the main body flap 3gda of the joining flap 3gd and bonding the main body flap 3gda to the back side of the first surface 3a, even when there is an unbonded extending flap 3gdb extended from the main body flap 3gda, the main body flap 3gda can be easily bonded to form the container 1. In addition, since the RFID module 5 is attached to the extending flap 3gdb and is positioned at a position overlapping the fourth dust flap 3q, when the extending flap 3gdb and the fourth dust flap 3q are attached to each other, the RFID module 5 is sandwiched between the extending flap 3gdb and the fourth dust flap 3q. Therefore, the fourth dust flap 3q is disposed to protect the RFID module 5. Accordingly, since rubbing between the containers 1 prevents shearing stress from being applied to the RFID module 5, the RFID module 5 is prevented from falling off. In addition, even when contents are put into the container 1, it is possible to prevent the RFID module 5 from falling off due to contact of the contents or hands.

### Second Exemplary Embodiment

Hereinafter, a container 1 of a second exemplary embodiment of according to the present invention will be described.

A difference between the container 1 of the second embodiment and the container 1 of the first embodiment is a difference in sheet resistance of the metal film 7. Hereinafter, this difference will be mainly described. It should be noted that in the description of the second embodiment, the description of elements having the same configuration, action, and function as those of the above-described first embodiment may be omitted to avoid redundant description. In the container 1 of the second embodiment, a configuration other than the points described below is the same configuration as the RFID module 5 of the first embodiment.

The sheet resistance of the metal film 7 of the container 1 of the second embodiment is larger than the sheet resistance of the metal film 7 of the container 1 of the first embodiment. When the sheet resistance of the metal film 7 is large, the following problems that have not occurred in the container 1 of the first embodiment occur.

In the container 1 of the first embodiment, a resonance phenomenon occurs in the entire metal film 7 as an antenna electrode, and an electromagnetic wave is emitted. The thickness of the metal film 7 in the first embodiment is, for example, more than 5 μm and 40 μm or less, and the sheet resistance of the metal film 7 is 0.05 Ω/□ or less.

The metal film of the container is usually formed for preventing food oxidation and improving designability, but even when the thickness of the metal film is, for example, a numerical value of one digit in units of μm such as 5 μm, when printing is made thereon by gravure printing or offset printing as a design, the printing thickness becomes about 1 μm. In this case, a step due to the thickness of the metal film as the antenna foil is generated in the printed matter, and this causes print misalignment (blurring or bleeding). For this reason, it has not been possible to directly print as a design on a container to which a conventional antenna foil is attached.

When a metal film as an antenna is formed by a vapor deposition method, the thickness of the metal film is further reduced to about 10 Å (=1 nm) to 10,000 Å (=1 μm). If the metal film has this degree of thickness, even when gravure printing is made on the metal film, print bleeding due to a step does not occur, but a metal film (deposited film) having this thickness, such as an aluminum foil, has a small film thickness, and thus has a large sheet resistance, for example, about 0.5 Ω to 50 Ω/□.

When the sheet resistance of the metal film increases, even when a series resonance phenomenon in which a standing wave is generated in the entire antenna electrode by the metal film occurs, the radiation power becomes almost heat due to the resistance of the metal foil, so that electromagnetic wave radiation cannot be performed as an antenna.

In addition, since the resistance value of the matching circuit unit between the RFIC and the antenna also becomes the same thickness as the metal film, the resistance value of the matching circuit unit increases, the matching loss increases, and the RFID module does not operate.

As described above, the antenna electrode made of a thin metal film cannot generate electromagnetic wave radiation due to a (e.g., series) resonance phenomenon, but when the metal film receives an electromagnetic wave, a current flows through the metal film so as to cancel the electromagnetic wave, and the electromagnetic wave is shielded. This current is also referred to as eddy current. When the eddy current flows, the current component flowing through the metal film is not caused by the resonance phenomenon of the antenna electrode, and thus can support all frequency components regardless of the electrode pattern shape. This eddy current is known as an effect of metal shielding, but is not usually used as an antenna.

Since the RFID module 5 includes a parallel resonance circuit RC1 as a filter circuit that transmits only a current at a natural resonance frequency to the RFIC 23, an eddy current is selected in frequency, and a current flows through the RFIC 23 to transmit energy. Only a specific frequency is selected between the metal film 7 as an antenna electrode and the RFID module 5, impedance matching is performed, and energy transmission between the RFIC 23 and the metal film 7 is enabled. In this manner, it is considered that communication with the RFIC 23 is enabled.

Therefore, if the container 1 of the second embodiment is used, even when the sheet resistance of the metal film 7 is high, communication is enabled using an eddy current that has not been conventionally used.

In addition, the state in which the surface resistance value of the metal film 7 is high occurs not only by the thickness of the metal film 7, but also by the method for manufacturing the metal film 7. For example, also when the metal film 7 is formed of a conductive paste, the sheet resistance may be 0.5 Ω or more. Even in this case, if the container 1 of the second embodiment is used, wireless communication can be performed.

In general, it is noted that the present invention is not limited to each of the exemplary embodiments described above, and can be modified and implemented as follows.
(1) In each of the above embodiments, the joining flap 3g is bonded to the first surface 3a, but the present invention is not limited thereto. For example, any flap of the first tuck flap 3h, the second tuck flap 3k, and the first dust flap 3m to the fourth dust flap 3q may be bonded to a surface overlapped according to alternative exemplary aspects. Moreover, the joining flap 3g does not need to be bonded to the first surface 3a.
(2) In each of the above embodiments, the container 1 is assembled, but the present invention is not limited thereto. The container 1 may be a bottle or a PET bottle according to an alternative exemplary aspect.
(3) In each of the above embodiments, the communication frequency band is the UHF band, but the present invention is not limited thereto. Wireless communication may be performed with a high frequency signal having a communication frequency (e.g., a carrier frequency) in the HF band according to alternative exemplary aspects. In this case, the entire length of the metal film 7 orthogonal to the first slit 71 is designed to receive a high-frequency signal in the HF band. It should be noted that the HF band is a frequency band of 13 MHz or more and 15 MHz or less.
(4) In each of the above embodiments, the RFID module 5 is attached to the metal film 7, but the present invention is not limited thereto. The RFIC 23 may be electrically connected to the metal film 7 through an inductor according to an alternative exemplary aspect. In this case, the inductor is formed on the metal film 7, functioning as an antenna pattern, side. When the inductor is formed on the metal film 7 side, the sheet resistance of the metal film 7 may be reduced by attaching a metal foil as in the first embodiment.
(5) In each of the above embodiments, on the metal film 7, a coating material may be applied to a region other than a place to which the RFID module 5 is attached to form a pattern and to improve the designability of the container 1. The metal film 7 and the first slit 71 may be formed on the second main surface 3t serving as the inner surface instead of the first main surface 3S serving as the outer surface of the base material 3.

Although the present invention is described with a certain degree of detail in each embodiment, the disclosure content of these embodiments should be changed in details of the configuration, changes in combination and order of elements in each embodiment can be achieved without departing from the scope and spirit of the disclosed invention.

### EXPLANATION OF REFERENCES

1 container
3 base material
3a first surface
3b second surface
3c third surface
3d fourth surface
3e fifth surface
3f sixth surface
3g joining flap
3h first tuck flap
3k second tuck flap
3m first dust flap
3n second dust flap
3p third dust flap
3q fourth dust flap
3s first main surface
3t second main surface
5 RFID module
5a front surface
5b back surface
7 metal film
7a, 7a2 first metal region
7b, 7b2 second metal region
15 adhesive layer
21 substrate
23 RFIC
23a terminal
23b terminal
25 protective film
27 protection film
29 first electrode
31 second electrode
33 third electrode
35 fourth electrode
37, 39 conductor pattern
41, 43, 45, 47 lower side
51, 53, 55, 57 upper side
61 side
71 first slit
72 second slit
73, 73B third slit
74 fourth slit
75 fifth slit
76 sixth slit
77 seventh slit
81, 82, 83, 84, 85 non-metal region
L1 first inductance element
L1a conductor pattern
L2a conductor pattern
L2 second inductance element
L2a conductor pattern
L2b conductor pattern
L3 third inductance element
L3a conductor pattern
L3b conductor pattern
L3c conductor pattern
L4 fourth inductance element
L5 fifth inductance element
Lg1 distance
Lg2 distance
CL center line
CP1 first current path
CP2 second current path
C1 capacitor
C2 capacitor

1. A container, having an assembled-box shape that includes an RFID module, the container comprising:
a base material having insulating properties and that is configured to form an outer shape of the container, the base material including:
first and second surfaces configured as any of a side surface, a top surface, and a bottom surface of the container, and
a first flap continuous with the first surface;
a metal film on the base material; and
a first slit in the metal film that separates the metal film on the first flap into first and second metal regions,
wherein the RFID module includes:
an RFIC element,
a filter circuit, and
first and second electrodes connected to the filter circuit,
wherein the first electrode of the RFID module is electrically connected to the first metal region of the metal film on the first flap,
wherein the second electrode of the RFID module is electrically connected to the second metal region of the metal film on the first flap,
wherein the first metal region of the metal film on the first flap is continuous with the metal film on the first surface, and
wherein in an assembled state of the container, the second metal region of the metal film on the first flap is capacitively coupled to the metal film on the second surface.

2. The container according to claim 1, wherein the filter circuit is configured to transmit, to the RFIC element, a current due to an electromagnetic wave at a natural resonance frequency being a communication frequency.

3. The container according to claim 1, further comprising a second slit that divides the metal film on the first surface and the metal film on the second surface.

4. The container according to claim 3,
wherein the base material has a third surface continuous with each of the first surface and the second surface, and
wherein the second slit is between the metal film on the second surface and the metal film on the third surface.

5. The container according to claim 4,
wherein the base material includes a first tuck flap continuous with the second surface on an opposite side from the third surface, and
wherein a third slit is between the metal film on the second surface and the metal film on the first tuck flap.

6. The container according to claim 5, wherein the metal film is on an entire surface of the base material except for the first slit, the second slit, and the third slit.

7. The container according to claim 5, wherein in the assembled state of the container, the metal film is not in a region of the second surface that overlaps the first metal region of the metal film on the first flap.

8. The container according to claim 5,
wherein the base material has a fourth surface continuous with the third surface on an opposite side from the second surface, and
wherein the base material includes a second tuck flap continuous with the fourth surface on an opposite side from the third surface.

9. The container according to claim 8, further comprising:
a fourth slit between the metal film on the third surface and the metal film on the fourth surface; and
a fifth slit between the metal film on the fourth surface and the metal film on the second tuck flap.

10. The container according to claim 3, wherein the base material includes:
a third surface continuous with the first surface on an opposite side from the first flap,
a fourth surface between the second surface and the third surface, the fourth surface continuous with each of the second surface and the third surface, and
a joining flap continuous with the second surface on an opposite side from the fourth surface.

11. The container according to claim 10, wherein:
the second slit is between the metal film on the second surface and the metal film on the fourth surface,
a third slit is between the metal film on the second surface and the metal film on the joining flap that separates the respective metal films, and
in the assembled state of the container, the second surface and the third surface face each other, and the metal film is not in a region of the second surface that overlaps the first metal region of the metal film on the first flap.

12. The container according to claim 3, wherein the base material includes:
a third surface continuous with the first surface on an opposite side from the first flap, and
a fourth surface between the second surface and the third surface, the fourth surface continuous with each of the second surface and the third surface.

13. The container according to claim 12, wherein in the assembled state of the container, the second surface and the third surface face each other, and the metal film is not in a region of the second surface that overlaps the second metal region of the metal film on the first flap.

14. The container including an RFID module according to claim 13, wherein the first flap is a tuck flap.

15. The container according to claim 1, wherein the first flap includes:
a main body flap connected to the first surface, and
an extending flap extending from the main body flap,
wherein the first metal region is disposed on the main body flap, and
wherein the second metal region is disposed on the extending flap.

16. The container according to claim 1, wherein, when the metal film is irradiated with an electromagnetic wave at a communication frequency, a current flows in a direction that intersects the first slit.

17. The container according to claim 1, wherein the filter circuit is an LC parallel resonance circuit.

18. The container according to claim 1, wherein a sheet resistance of the metal film is 0.5 Ω/□ or more.

19. The container according to claim 18, wherein the metal film has a thickness of 1 nm or more and 1 μm or less.

20. A container having an assembled-box shape that includes an RFID module, the container comprising:
an insulating base that forms an outer shape of the container and includes:
first and second surfaces configured as any of a side surface, a top surface, and a bottom surface of the container, and
a first flap continuous with the first surface;
a metal film on the insulating base; and
a first slit in the metal film that separates the metal film on the first flap into first and second metal regions,
wherein the RFID module includes:
an RFIC element,
a filter circuit, and
a first electrode that electrically connects the filter circuit to the first metal region of the metal film on the first flap,
a second electrode that electrically connects the filter circuit to the second metal region of the metal film on the first flap,
wherein the first metal region of the metal film on the first flap is continuous with the metal film on the first surface, and
wherein in an assembled state of the container, the second metal region of the metal film on the first flap is capacitively coupled to the metal film on the second surface.
